(19) United States
(12) Patent Application Publication
(10) Pub. No.: US 2007/0090313 A1
(43) Pub. Date: Apr. 26, 2007

(54) Clamp for an IV line

(76) Inventor: Shawn-Kristin Reynolds, Schereville, IN (US)

Correspondence Address: WALLENSTEIN & WAGNER, LTD., 311 SOUTH WACKER DRIVE, 53RD FLOOR, CHICAGO, IL, 60606, US

(21) Appl. No.: 11/246,501

(22) Filed: Oct. 7, 2005

(51) Int. Cl. F16K 7/04

(52) U.S. Cl. 251/4

(57) ABSTRACT

A safety clamp that has a base with a first surface and a second surface. The first surface has a plurality of clamps attached to the first surface of the base wherein at least one clamp is configured to receive a delivery tube and secure the delivery tube to the base. The clamp has a receiving portion, an intermediary opening, and a clamping portion, wherein the clamp portion reduced the diameter of the delivery tube to prevent flow through the tubing. The second surface of the base has an indicia writing surface to record patient information, type of solution, personnel information and/or the date.

### CROSS-REFERENCE TO RELATED APPLICATIONS

None.

### FEDERALLY SPONSORED RESEARCH OR DEVELOPMENT

None.

### TECHNICAL FIELD

The invention relates to a safety clamp and safety method for IV lines or tubing, and more particularly for a device for securing IV lines into a clamp to regulate flow through IV lines.

### BACKGROUND OF THE INVENTION

Intravenous lines, or IV lines, are commonly used in the medical profession to treat patients by introducing treatments directly into a patient's blood stream such as medications, nutrients, therapeutic agents, drugs and a variety of other liquids. Typically, an intravenous bag, or a primary bag, has a primary line that is connected to a drug delivery, or secondary bag, that has a secondary line by means of a connection such as a Y-connector. The solutions combine into an injection line that is subsequently introduced into a patient's body. The concentration of the treatment that a patient receives is extremely critical, because the concentration of the treatment takes into consideration numerous variables depending on each individual patient. Thus it is imperative that a patient receives the proper dosage of treatment in order for it to be effective.

In order to prevent dilution of treatments by a saline flush, medical personnel currently manipulate the flush line, which is often referred to as the primary line, by folding it over several times, or kinking it, and securing it together with medical tape to obstruct the flow of the flush through the primary line. Medical personnel have found that manipulating the primary line in such a manner prevents the treatment and the flush from being administered simultaneously which can result in dilution. Furthermore, by allowing medical personnel to regulate when the flush is administered, it allows them to wait until all the treatment is administered and then flush the injection line to ensure all the treatment is in fact delivered. One major problem with physically manipulating the IV line by taping it together is that if a patient begins to have an allergic reaction and/or goes into anaphylactic shock, the medical personnel cannot readily remove the taped tubing in order to flush the treatment the patient is having an adverse reaction to in a timely manner. Failure in removing the taped tubing in a timely manner could result in a disastrous medical emergency or even death. Furthermore, kinking and securing the IV tubing with tape is time consuming and tedious for medical personnel and wastes material. Thus, there is a need for an IV safety clamp that adequately obstructs and regulates the flow through IV lines. While roller clamps are sometimes used to slow or obstruct the flow of fluids through an IV tube, roller clamps are prone to human error because failure to properly secure the roller clamp can result in leakage. Furthermore, roller clamps have a tendency of becoming loose thereby causing unwanted leakage.

The present invention is provided to solve the problems discussed above, and other problems, and to provide advantages and aspects not provided by prior IV clamps of this type. A full discussion of the features and advantages of the present invention is deferred to the following detailed description, which proceeds with reference to the accompanying drawings.

### SUMMARY OF THE INVENTION

According to a first aspect of the present invention, a safety clamp is disclosed for an intravenous delivery tube having a base with a first surface and a second surface. The first surface of the base has at least one clamp molded onto the first surface of the base, and the second surface of the base has an indicia writing area.

According to yet another aspect of the present invention, a safety clamp is disclosed for an intravenous delivery tube having a base with a first surface and a second surface. The first surface has a plurality of clamps attached to the first surface of the base wherein at least one clamp is configured to receive a delivery tube that secures the delivery tube to the base. The clamp has a receiving portion, an intermediary opening, and a clamping portion, wherein the clamping portion reduced the diameter of the delivery tube to prevent flow through the tubing. The second surface of the base has an indicia writing surface.

According to yet another aspect of the present invention, a method of manipulating the diameter of an intravenous delivery tube to control the flow of substance through a tubing is disclosed. The method provides a base having a first surface and a second surface wherein the first surface has a plurality of clamps capable of receiving a delivery tube. The method also requires introducing the delivery tube into the plurality of clamps by inserting the tubing into a receiving portion and then manipulating the diameter of the tubing by fastening the tubing into the clamping portion. Upon insertion of the delivery tube into the clamping portion, the diameter of the delivery tube is reduced to prevent fluid flow through the tube.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a safety clamp of the present invention;

FIG. 2 is a perspective view of the base with the delivery tube of the present invention;

FIG. 3 is a top view of the safety clamp of the present invention;

FIG. 4 is a top view of the base of the present invention;

FIG. 5 is a top view of the base with the delivery tube of the present invention;

FIG. 6 is a top view of the second surface of the present invention;

FIG. 7 is a top view of the first surface of the present invention;

FIG. 8 is an alternative embodiment of the present invention; and

FIG. 9 is a cross-section of the delivery tube of FIG. 2.

### DETAILED DESCRIPTION

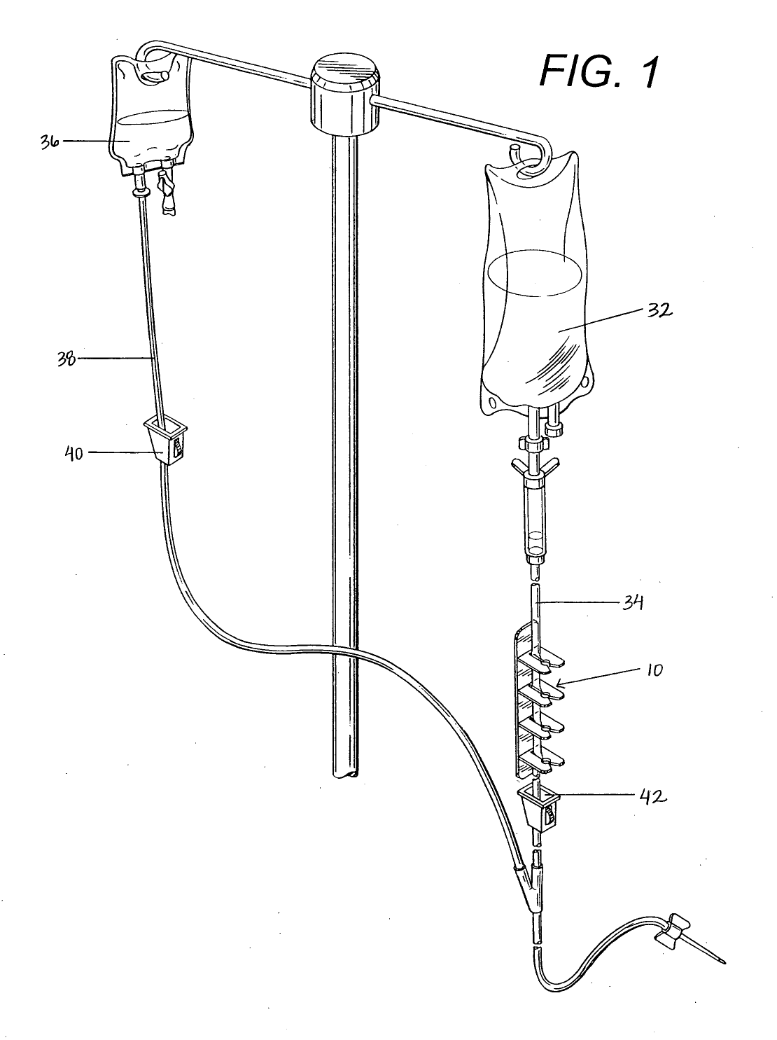

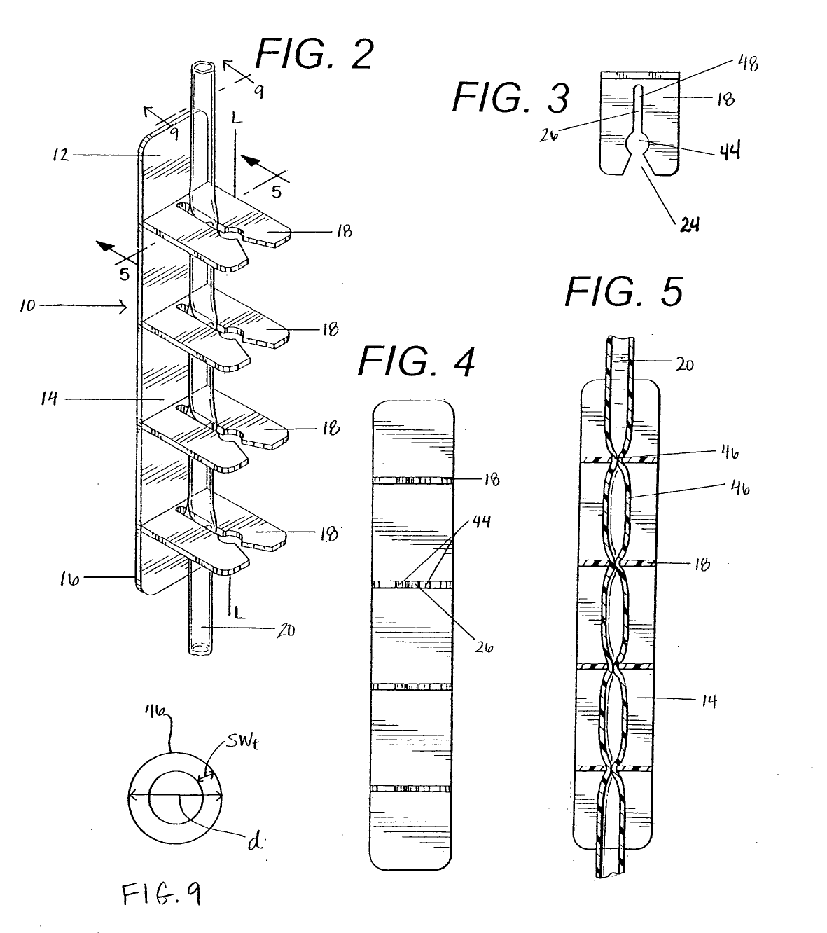

Referring to the drawings, FIGS. 1 and 2 disclose a safety clamp 10 according to the present invention. The safety clamp 10 comprises a base 12 having a first surface 14 and a second surface 16. The base 12 can be made of a plastic hardened material. Although the dimensions of the base may vary, in one preferred embodiment, the base 12 is approximately one inch or 0.254 cm wide and three inches or 7.62 cm long as shown in FIG. 2. Although one preferred embodiment is disclosed having a rectangular configuration, it is contemplated that the base 12 can be of various sizes or shapes as long as it has a plurality of clamps 18 to secure an intravenous flexible tube or delivery tube 20. As shown in FIG. 9, the delivery tube 20 is a traditional IV line that has a diameter, d. The tubing 20 has sidewalls 46 that have a thickness, swₜ. The diameter, d, refers to the distance between the two outer surfaces of the sidewalls 46 as shown in FIG. 9. For example, a typical intravenous delivery tube may have a diameter, d, of approximately 3.5-4.0 millimeters (0.125-0.150 inches) with a sidewall thickness of approximately 0.5-0.76 millimeters (0.02-0.03 inches). The base 12 has a thickness that allows the device to be readily manipulated by any medical personnel. The thickness of the base 12 may vary, however in one preferred embodiment, the thickness of the base is approximately 0.25 cm. Since it is contemplated that the safety clamp 10 can be stored in large bins to allow medical personnel to easily grab a safety clamp 10 as needed, it is within the scope of the invention for the base 12 to have rounded edges as shown in FIGS. 2, 4 and 5. The rounded edges of the base 12 serve to prevent medical personnel from getting hurt by the sharp edges of the base 12 when reaching into the bins. Also shown in FIG. 7, the base 12 may have an embossed configuration on the base such as in the form of an “s” pattern.

As shown in FIGS. 1 and 2, the first surface 14 of the base 12 has a plurality of clamps 18. Although the number of clamps may vary, in one preferred embodiment as shown in FIG. 2, four clamps 18 are disclosed attached to the first surface 14 of the base 12. In one preferred embodiment the clamps 18 may be molded onto the first surface 14 of the base 12. While four clamps are sufficient to completely close off flow through the IV tube, it is contemplated that more or less clamps may be used as long as flow through the tube can be completely obstructed. It is preferable to have more than one clamp as a safety precaution in the event that one clamp has slight leakage, the fluid flow will be stopped by any subsequent clamps. As shown in FIG. 5, the purpose of the clamps 18 is to regulate flow from the intravenous tube into the patient by manipulating the diameter of the tube as will be discussed in more detail below. The clamps 18 of base 12 should be evenly positioned on the first surface 14 so that a user can readily secure the delivery tube 20 into the clamps 18 of the base 12 or readily remove the delivery tube 20 from the clamps 18 of the base 12. In one preferred embodiment the clamps 18 are positioned approximately 1.0 cm apart from one another. Furthermore, the clamps 18 are positioned so they are substantially perpendicular to the base 12 as shown in FIG. 2.

FIG. 3 shows a top view of the clamp 18. The clamp 18 has a receiving portion 24, a intermediary opening 44, and a clamping portion 26. The receiving portion 24 is configured so that a user can easily introduce the delivery tube 20 into the safety clamp 10. As shown in FIG. 3 In one preferred embodiment, the receiving portion 24 has a width that is greater or equal to the diameter, d, of the tubing 20. Once a user inserts the tubing into the receiving portion 24, they can then fasten the tubing 20 into the intermediary opening 44. The intermediary opening 44 has a width such that when the tubing 20 is positioned into the intermediary opening 44, the diameter, d, of the tubing 20 is not altered. The intermediary opening 44 may have a circular configuration which holds the tubing 20 into the safety clamp 10 without obstructing flow through the tubing 20. The diameter of the circular configuration of the intermediary opening 44 is equal to or slightly greater than the diameter of the tubing 20. It is important for the diameter of the intermediary opening 44 to be equal to or slightly greater than the diameter of the tubing 20 so that fluid can flow through the tubing without being obstructed. In the event a user would like to completely obstruct or prevent the flow of fluid through the tubing 20, the tubing 20 can be secured into the clamping portion 26 as shown in FIG. 5. The clamping portion 26 completely prevents fluid flow through the tubing 20. The clamping portion 26 comprises a groove 48 that is configured to have a width of approximately equal to or less than the total thickness of two of the sidewalls, swₜ, 46 of the tubing 20. This is important because when the tubing 20 is fastened into the clamping portion 26 the diameter, d, of the tubing 20 is reduced so that the sidewalls 46 of the tubing 20 come into direct contact to prevent all fluid flow through the tubing 20. FIG. 5 shows how the diameter of the tube is reduced so that the walls of tubing 20 come together to completely prevent any flow through the tubing 20 when the tubing 20 is fastened into the clamps 18. Therefore, in order for fluid flow to be prevented, the clamping portion 26 must have a width that is equal to or less than the total thickness of the two sidewalls 46 together. As shown in FIG. 5, by constructing the width of the clamping portion 26 to be less than the total thickness of the two sidewalls 46, the clamping portion 26 essentially pinches the tubing 20 close.

As shown in FIG. 2 and 5, the clamps 18 of the first surface 14 align with one another so that the clamps 18 run directly along the same axis L. It is important for the clamps 18 to all have the same axis L to prevent any kinking or twisting of the delivery tube 20. With all of the clamps 18 directly aligned, medical personnel can easily fasten the tubing 20 into the clamping portion 26 when they want to obstruct any fluid flow through the tubing 20, and they can easily pull the tubing 20 out of the clamping portion 26 into the intermediary opening 44 or remove the tubing 20 altogether from the safety clamp 10 to rapidly flush the tubing 20, as will be described in greater detail below. It is contemplated that numerous different clamping devices may be used in conjunction with the present invention as shown in FIG. 8.

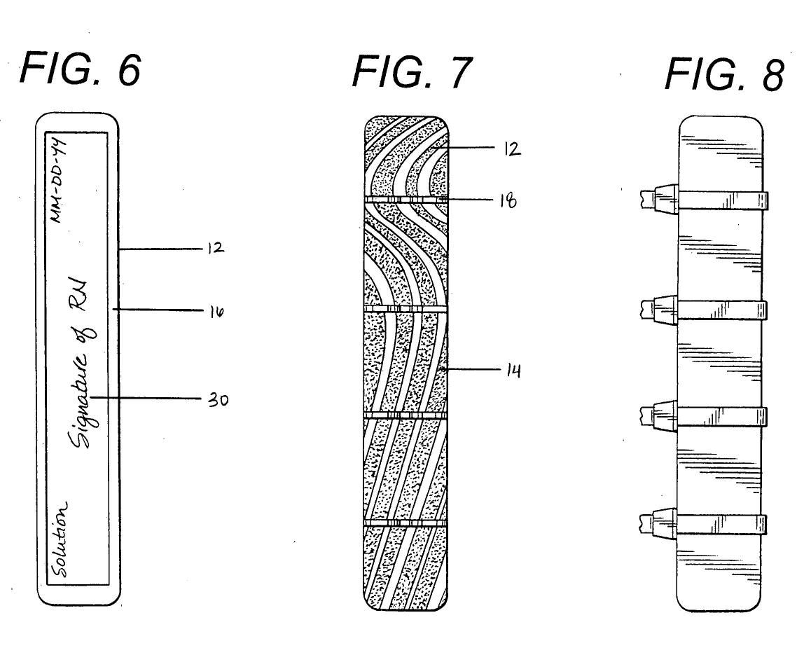

The base 12 of the safety clamp 10 has a second surface 16 as shown in FIG. 6. The second surface 16 has an indicia writing surface 30. The indicia writing surface 30 may be in the form of a label or tape-like material that can be adhesively applied to the second surface 16 that allows medical personnel to write pertinent information relating to the type of treatment or fluid that is being administered to a patient. For example, a patient's name, the type of treatment or flush agent being infused, the date of infusion and the medical personnel's signature can be written on the indicia writing surface 30. It is preferable that the indicia writing surface 30 is able to accept ink without smearing so that any information does not accidentally rub off. The indicia writing surface 30 may also be of a material on which it is possible to write with a pen or pencil. Alternatively, the second surface 16 may be used to apply a label that has been previously typed with all of the patient's information. It is understood that other methods of providing a label on the second surface 16 of the base 12 are within the scope of this invention. It is contemplated that the safety clamp 10 may be disposable so as to prevent any confusion or cross contamination between patients.

In operation, the intravenous safety clamp 10 can be used for preventing dilution of medical treatments, such as chemotherapy, blood products and/or antibiotics, that are being administered via intravenous tubing. Typically when medical personnel are preparing a patient for treatment such as chemotherapy, they will have two separate IV lines, a flush line and a treatment line. Typically, the flush lines are referred to as the primary line 34 that is used for a flush such as 0.9 NS or D5, and the treatment line is referred to as the secondary line 38 that is used to administer the treatment such as a chemotherapy drug. It should be noted that in certain situations medical personnel may refer to the flush line as the secondary line and the treatment line as the primary line. FIG. 1 shows a first intravenous bag 32 with the primary line 34 that houses the flush solution. FIG. 1 also shows a second intravenous bag 36 with a secondary line 38 that houses the treatment. Prior to administering the treatment to the patient, the primary line 34 will be clamped into the safety clamp 10 so as to prevent any dilution of the treatment from the secondary line 38. FIG. 1 shows the safety clamp 10 in position prior to administering treatment. At this time, the safety clamp 10 is secured in place on the primary line 34 to prevent any flow of flush solution that could potentially dilute the treatment. Typically when a patient's treatment begins, medical personnel will open the traditional roller clamp 40 of the secondary line 38 to allow the treatment to flow through the secondary line 38. As such, securing the safety clamp 10 in position on the primary line 34 ensures that the patient receives the precise concentration of treatment that has been prescribed. Additionally, it requires less time and money for medical personnel to simply fasten the tubing 20 into the safety clamp 10 rather than kinking the tubing and taping it together as it has been done in the past. Also shown in FIG. 1, a roller clamp 42 may be used in conjunction with the safety clamp 10 to ensure further safety precautions. When the patient has completed receiving the treatment and is ready to receive the flush, the medical personnel simply removes the safety clamp 10 to flush the lines to make sure all of the treatment is in fact administered.

In another preferred embodiment, the intravenous safety clamp 10 may be fastened to the secondary line. As mentioned above, medical treatments that require a patient to receive antibiotics will house the antibiotic in an IV bag that is connected to the primary line and the flush will be connected to the secondary line. Thus certain circumstances will require the flexible IV tubing to be clamped into the secondary line. It is contemplated that the safety clamp 10 can be used on any intravenous tubing to obstruct fluid flow.

While the safety clamp 10 ensures that treatments are not diluted, the safety clamp 10 can also help a patient that has an allergic reaction and/or goes into anaphylactic shock. If a patient is receiving a treatment and has an adverse reaction to the treatment due to an allergic reaction or because they were given an incorrect dosage or medication, the medical personnel may need to immediately open the flush line or primary line 34 therefore occluding the secondary line 38. The safety clamp 10 allows for the medical personnel to immediately remove the safety clamp 10 from the primary line 34 to allow the flush to rush through the line immediately and dilute the agents causing the reaction. In the event a patient would go into anaphylactic shock and the traditional kinking method was used, the medical personnel would have a great deal of trouble removing the tape off the tubing in order to allow the flush to rapidly run through a patient's IV lines.

While this invention is susceptible of embodiments in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

While the specific embodiments have been illustrated and described, numerous modifications come to mind without significantly departing from the spirit of the invention, and the scope of protection is only limited by the scope of the accompanying Claims.

What is claimed is:

1. A safety clamp for an intravenous delivery tube, wherein the tube has a diameter, d, and a sidewall thickness, swₜ, the safety clamp comprising:
a base having a first surface and a second surface;
at least one clamp attached to the first surface of the base; and
the second surface of the base comprising an indicia writing area.

2. The safety clamp of claim 1, wherein the base has a substantially rectangular shape.

3. The safety clamp of claim 1, wherein the first surface of the base has a plurality of clamps.

4. The safety clamp of claim 1, wherein the clamp has a receiving portion.

5. The safety clamp of claim 4, wherein the receiving portion is V-shaped.

6. The safety clamp of claim 4, wherein the receiving portion has a width that is greater than or equal to the diameter of the delivery tube.

7. The safety clamp of claim 1, wherein the clamp has a intermediary opening.

8. The safety clamp of claim 7, wherein the intermediary opening has a width that is greater than the diameter of the delivery tube.

9. The safety clamp of claim 7, wherein the intermediary opening has a diameter that is greater than the diameter of the delivery tube.

10. The safety clamp of claim 1, wherein the clamp has a clamping portion.

11. The safety clamp of claim 10, wherein the clamping portion comprises a groove.

12. The safety clamp of claim 11, wherein the groove has a width that is less than or equal to the thickness of the two sidewalls of the delivery tube.

13. A safety clamp for an intravenous delivery tube, wherein the tube has a diameter, d, and a sidewall thickness, swₜ, the safety clamp comprising:
a base having a first surface and a second surface;
the first surface having a plurality of clamps attached to the first surface of the base wherein at least one clamp is configured to receive a delivery tube and secure the delivery tube to the base;
the second surface of the base comprising an indicia writing surface;
wherein each of the plurality of clamps has a receiving portion, an intermediary opening and a clamping portion; and upon insertion of the delivery tube into the clamping portion, the diameter of the delivery tube is reduced to prevent fluid flow through the tube.

14. The safety clamp of claim 13, wherein the receiving portion is V-shaped.

15. The safety clamp of claim 14, wherein the receiving portion has a width that is greater than or equal to the diameter of the delivery tube.

16. The safety clamp of claim 13, wherein the intermediary opening has a width that is greater than the diameter of the delivery tube.

17. The safety clamp of claim 13, wherein the intermediary opening has a diameter that is greater than the diameter of the delivery tube.

18. The safety clamp of claim 13, wherein the clamping portion comprises a groove that has a width that is less than or equal to the thickness of the two sidewalls of the delivery tube.

19. A method of preventing fluid flow through an intravenous delivery tube, comprising the steps of:
providing a base having a first surface and a second surface wherein the first surface has a plurality of clamps capable of receiving a delivery tube, wherein the delivery tube has sidewalls; and
introducing the delivery tube into the plurality of clamps by inserting the tubing into a receiving portion and then reducing the diameter of the tubing by fastening the tubing into the clamping portion.

20. The method of preventing fluid flow though an intravenous delivery tube of claim 19, wherein reducing the diameter of the tubing by fastening the tubing into the clamping portion comprises the steps of bringing the sidewalls of the tubing into direct contact.
